(19) United States
(12) Patent Application Publication
(10) Pub. No.: US 2023/0376783 A1
(43) Pub. Date: Nov. 23, 2023

(54) DYNAMIC INTENT-BASED NETWORK COMPUTING JOB ASSIGNMENT USING REINFORCEMENT LEARNING

(71) Applicant: NEC Laboratories America, Inc., Princeton, NJ (US)

(72) Inventors: Philip JI, Cranbury, NJ (US); Ting WANG, West Windsor, NJ (US); Zilong YE, La Verne, CA (US)

(73) Assignee: NEC Laboratories America, Inc., Princeton, NJ (US)

(21) Appl. No.: 18/319,472

(22) Filed: May 17, 2023

Related U.S. Application Data
(60) Provisional application No. 63/343,664, filed on May 19, 2022.

(51) Int. Cl. G06N 3/092; G06N 3/045

(52) U.S. Cl. CPC G06N 3/092; G06N 3/045

(57) ABSTRACT

An advance in the art is made according to aspects of the present disclosure directed to a method that determines virtual topology design and resource allocation for dynamic intent-based computing jobs in a mobile edge computing infrastructure when client requests are dynamic. Our method according to aspects of the present disclosure is an unsupervised machine learning approach, so that there is no need for manual labeling or pre-processing in advance, while a training process and decision making is performed online. In sharp contrast to the prior art, our method according to aspects of the present disclosure utilizes reinforcement learning techniques to make an efficient assignment in which two neural networks—a policy neural network and a value neural network—are used interactively to achieve the assignment. A training process is performed through a batch (or group) processing style in an online manner.

### CROSS-REFERENCE TO RELATED APPLICATIONS

This application claims the benefit of U.S. Provisional Patent Application Ser. No. 63/343,664 filed May 19, 2022, and U.S. Provisional Patent Application Ser. No. 63/413,668 filed Oct. 6, 2022, the entire contents of each of which are incorporated by reference as if set forth at length herein.

### FIELD OF THE INVENTION

This application relates generally to virtual topology design a resource allocation for intent-based computing jobs when client requests are dynamic or online, in real-time. More particularly, it pertains to a technique of reinforcement learning to facilitate the intelligent assignment over time, that employs unsupervised machine learning.

### BACKGROUND OF THE INVENTION

Recently, there has emerged a variety of applications for Internet of Things (IoT) and mobile edge computing (MEC) including, distributed fiber optic sensing, autonomous driving, etc. To provide a quality of service, the infrastructure providers may offer new types of services that only require knowledge of client intent for example, the size of the data to be processed, the computer model, etc., rather than a detailed (or restricted) virtual topology information. As will be understood, such service offerings are flexible for the client as it requires little information from that client. Additionally, it may also allow the infrastructure owner/provider to better utilize their physical resources, as the infrastructure owner must jointly consider virtual topology design and resource allocation based on the client intent. In this process, there is a critical challenge for the infrastructure owner to accommodate a client's requests when such requests arrive dynamically.

### SUMMARY OF THE INVENTION

An advance in the art is made according to aspects of the present disclosure directed to a method that determines virtual topology design and resource allocation for dynamic intent-based computing jobs in a mobile edge computing infrastructure when client requests are dynamic. Our method according to aspects of the present disclosure is an unsupervised machine learning approach, so that there is no need for manual labeling or pre-processing in advance, while a training process and decision making is performed online.

In sharp contrast to the prior art, our method according to aspects of the present disclosure utilizes reinforcement learning techniques to make an efficient assignment in which two neural networks—a policy neural network and a value neural network—are used interactively to achieve the assignment. A training process is performed through a batch (or group) processing style in an online manner.

In further contrast to the prior art, in our process of reinforcement learning, we define (1) a novel reward function to evaluate the assignment decision, (2) a novel action space that exhausts all the possible strategies for a request, and (3) a novel batch processing technique for training the two neural networks.

As we shall describe, our inventive procedure addresses the virtual topology design and resource allocation for dynamically arriving intent-based computing jobs in the mobile edge computing infrastructure. The procedure applies a novel way to use the reinforcement learning technique to efficiently address the problem. The procedure applies a novel reward system to be used in the reinforcement learning model. The procedure applies a novel action space to be used in the reinforcement learning model. The procedure applies a novel way of creating the policy neural networks and the value neural networks that are used in the reinforcement learning model. The procedure applies a novel way of batch processing for training the policy neural networks and the value neural networks in the reinforcement learning model. The procedure provides a guideline about what virtual topology to use to efficiently accommodate the client's computing job request, and the procedure provides a guideline about how to allocate the computing resource and the bandwidth resource to efficiently accommodate the client's computing job requests.

### BRIEF DESCRIPTION OF THE DRAWING

FIG. 1(A) and FIG. 1(B) are flow diagrams showing an illustrative reinforcement learning based procedure according to aspects of the present disclosure;

FIG. 2. is a flow diagram showing an illustrative training process of the value neural networks according to aspects of the present disclosure; and

FIG. 3 is a flow diagram showing an illustrative training process of the policy neural networks according to aspects of the present disclosure;

FIG. 4 is a schematic diagram showing illustrative autonomous vehicle system application of our inventive method according to aspects of the present disclosure;

FIG. 5 is a schematic diagram showing illustrative sensor network application of our inventive method according to aspects of the present disclosure;

FIG. 6 is a schematic diagram showing illustrative smart retail application of our inventive method according to aspects of the present disclosure;

FIG. 7 is a schematic diagram showing illustrative intent-based computing job assignment framework and reinforcement learning-based solution according to aspects of the present disclosure.

FIG. 8 is a schematic diagram showing illustrative computer structure that may be used in conjunction with our inventive method according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

As we have previously noted, our inventive procedure/method according to aspects of the present disclosure is based on a reinforcement learning technique. It is an unsupervised learning approach, where training and decision making is adaptively performed to accommodate dynamic requests.

In our process, we employ two neural networks, namely, policy neural networks and value neural networks. These two neural networks interact with each other to gain intelligence for making an efficient assignment for a virtual topology design and resource allocation for dynamic intent-based job requests.

In the process of reinforcement learning, we define (1) a novel reward function to evaluate the assignment decision, (2) a novel action space that exhausts all the possible strategies for a request, and (3) a novel batch processing technique for training the two neural networks as mentioned above. The detailed steps of the proposed invention are described below.

The Reinforcement Learning Based Approach

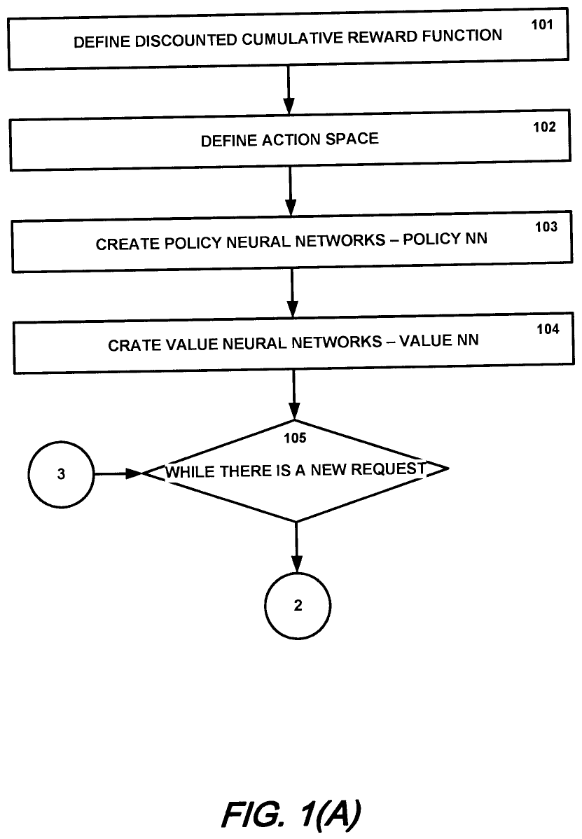

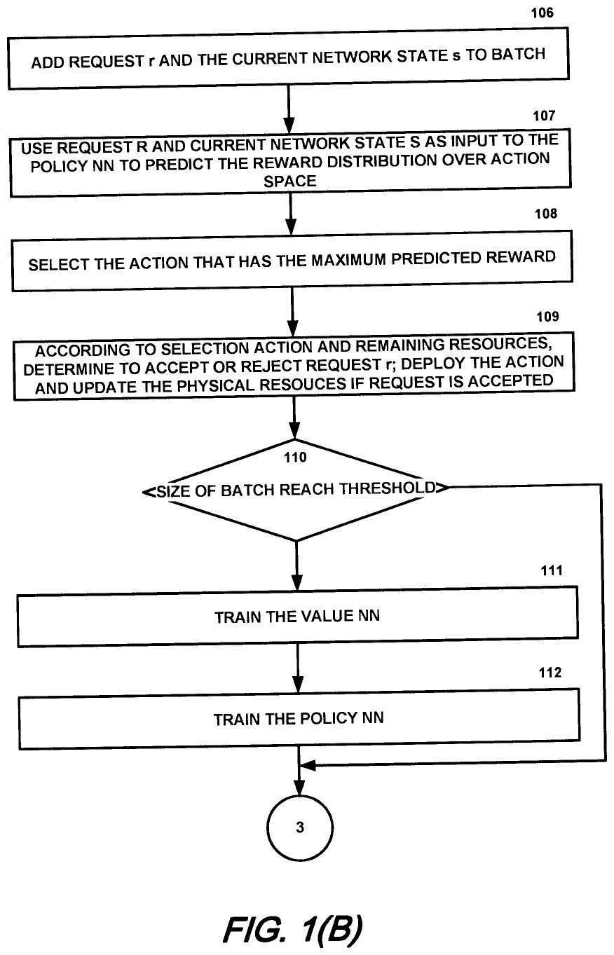

FIG. 1(A) and FIG. 1(B) are flow diagrams showing an illustrative reinforcement learning based procedure according to aspects of the present disclosure. Simultaneous reference is now made to these figures.

Step 101: In this step, a novel discounted cumulative reward function is defined to be used in the reinforcement learning process. Firstly, we define that a reward of 1 will be gained if a request is accepted; otherwise, a reward of 0 will be gained if a request is rejected. Secondly, in terms of a long-term gain in the reinforcement learning process, we define a discounted cumulative reward, which is the weighted sum of rewards of a given request and the requests that arrive after the given request. The weight for the given request's award will be αϵ(0, 1), which is a parameter that can be configured by the user. The requests that come after the given request will have a weight of αⁱ, where i=2, 3, 4 . . . . Here, the request immediately after the given request will have i=2, and the next following request will have i=3, so on so forth.

Step 102: An action space is created in this step. More specifically, the procedure enumerates all the possible actions that can be used to determine the virtual topology design and resource allocation and incorporates them into this action space.

Step 103: This step initializes policy neural networks. The policy neural networks work interactively with the value neural networks (to be described in step 104) to determine the virtual topology design and the resource allocation for an intent-based request. Assume the given mobile edge computing infrastructure G(V, E) has V physical nodes and E physical links, and the intent-based job request include N intent information, such as data size, computing model, etc. The input to the policy neural networks includes the network state (e.g., the remaining computing resources on each physical node and the remaining bandwidth resources on each physical link) and the request information, so the number of input nodes will be V+E+N. The number of hidden layers and the number of hidden nodes in each hidden layer are parameters that can be configured case by case. The output of the policy neural networks are the predicted discounted cumulative reward distribution over different actions in the action space, so the number of output nodes are the number of possible actions in the action space from step 102.

Step 104: This step initializes value neural networks. The value neural networks are used to provide a predicted discounted cumulative reward for each action that will be evaluated by the policy networks. The input of the value neural networks consists of the network state, so the number of input nodes is V+E. The number of hidden layers and the number of hidden nodes in each layer are parameters that can be configured case by case. The output of the value neural networks is the predicted discounted cumulative reward for the input network state, so number of output node is 1.

Step 105: The intent-based requests arrive dynamically. This step checks if a request arrives. If yes, it proceeds to step 106; otherwise, it will wait at this current step until a request arrives.

Step 106: This step adds the arriving request r and the current network state s to a batch. Here, the request intent information, such as the data size, the computing model, etc., will be sent to the batch. The network state s includes the remaining computing resources at each physical node and the remaining bandwidth resources at each physical link.

Step 107: This step predicts the discounted cumulative reward for each possible action corresponding to the given request r. More specifically, this step uses the request intent information and the network state s as input to the policy neural networks, and calculates the predicted discounted cumulative reward distribution over all the possible actions in the action space.

Step 108: This step compares the predicted discounted cumulative rewards for all the possible actions in the action space, and selects the action that has the maximum predicted discounted cumulative reward.

Step 109: This step determines to accept or reject the request r, based on the selected action in step 108 and whether there are enough remaining computing resources and bandwidth resources on the physical infrastructure to support the selected action. If the request r is accepted, then this step also needs to actually deploy the selected action to accommodate the request r, and update the remaining computing resources and bandwidth resources on the physical infrastructure.

Step 110: This step check the size of the batch. If the number of requests (and their corresponding network state) meets a pre-set threshold, then proceed to step 111 and step 112 to train the policy neural networks and the value neural networks; otherwise, go back to step 105 to wait for the next arriving request. The application of batch processing ensures that the training of policy neural networks and the value neural networks can yield an accurate prediction.

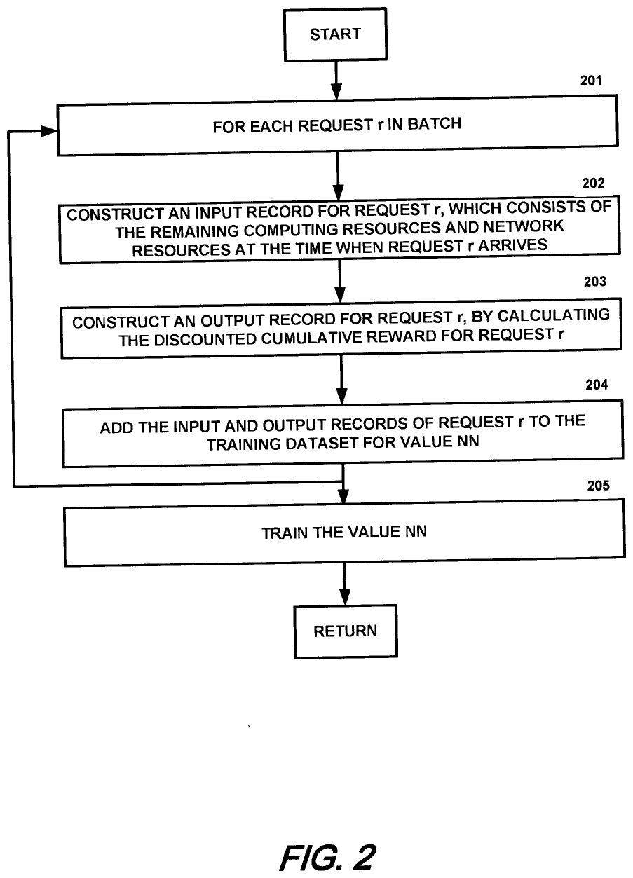

Step 111: This step trains the value neural networks. The detailed steps are shown in FIG. 2, and will be presented in the following parts.

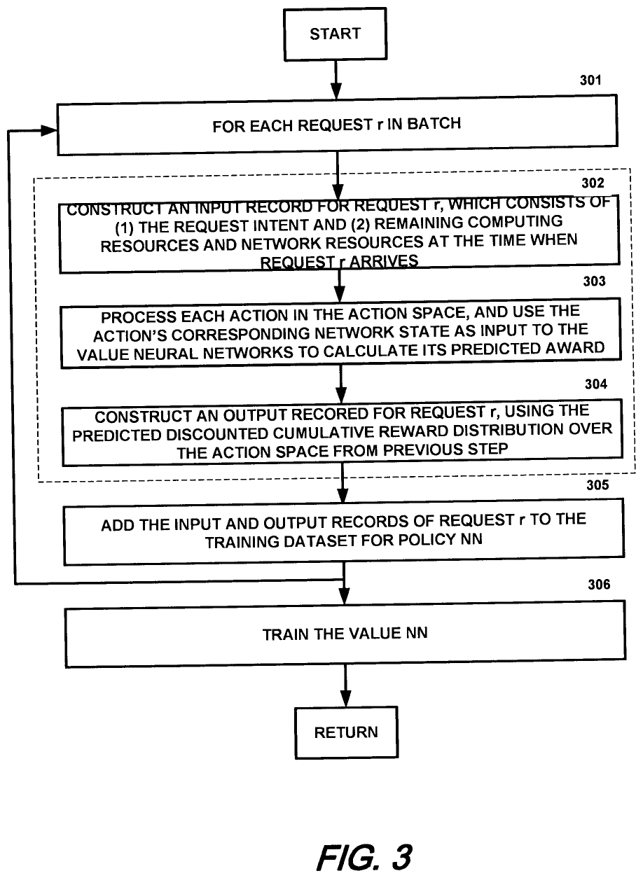

Step 112: This steps trains the policy neural networks. The detailed steps are shown in FIG. 3, and will be presented in the following parts.

Training the Value Neural Networks

FIG. 2. is a flow diagram showing an illustrative training process of the value neural networks according to aspects of the present disclosure. Reference is now made to that figure.

Step 201: This step is the entering point of a for-loop. It will check each request r (and its corresponding network state) in the batch, and repeat steps 202, 203 and 204.

Step 202: This step constructs an input record, which consists of the network state for request r. The network state includes the remaining computing resources and the bandwidth resources on the physical fog infrastructure, at the time when request r arrives.

Step 203: This step constructs an output record. It is the discounted cumulative rewards for request r, which can be calculated using the method described in step 101.

Step 204: This step add the above input record (step 202) and output record (step 203) as a pair to a training dataset.

Step 205: This step performs the actual training of the value neural networks, using the training dataset obtained after step 201 through step 204.

Training the Policy Neural Networks

FIG. 3 is a flow diagram showing an illustrative training process of the policy neural networks according to aspects of the present disclosure. Reference is now made to that figure.

Step 301: This step is the entering point of a for-loop. It will check each request r (and its corresponding network state) in the batch, and repeat steps 302 through step 305.

Step 302: This step constructs an input record, which consists of (1) the intent information of request r, and (2) the network state such as the remaining computing resources and the bandwidth resources on the physical infrastructure, at the time when request r arrives.

Step 303: This step is the interaction between value neural networks and the policy neural networks. More specifically, this step checks each possible action in the action space. For the action being processed, this step uses the action's corresponding network state as input to the value neural networks to calculate the predicted discounted cumulative reward for the given action. Here, each request has a predicted discounted cumulative reward distribution over all the possible actions in the action space.

Step 304: This step constructs an output record. It is the predicted discounted cumulative reward distribution over the action space, which is calculated from step 303.

Step 305: This step add the above input record (step 302) and output record (step 304) as a pair to a training dataset.

Step 306: This step performs the actual training of the policy neural networks, using the training dataset obtained after step 301 through step 305.

As those skilled in the art will understand and appreciate, our inventive method is applicable to a a wide range of real-life applications. For example, it can be applied in the autonomous vehicle (self-driving car) system, in which there are many dynamic computation needs arriving constantly, such as reading traffic signs, monitoring road condition, computing a route, responding to sudden events, etc.

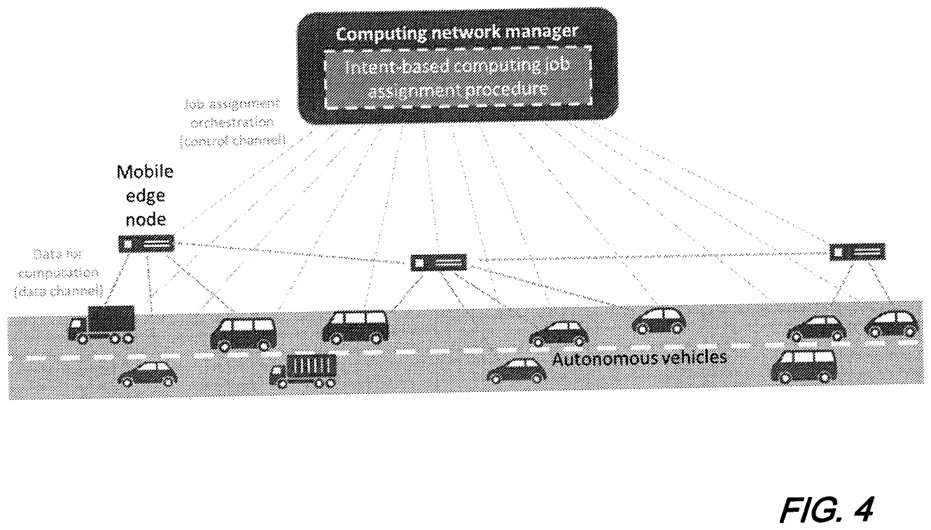

FIG. 4 is a schematic diagram showing illustrative autonomous vehicle system application of our inventive method according to aspects of the present disclosure. As shown in this figure, the system includes not only the individual vehicles (the client/customer), but also a mobile edge computing infrastructure installed along the roadside, as well as a computing network manager that connects to all vehicles and the mobile edge computing nodes through wireless or wired connections. The computing network manager orchestrates the computation operation using the intent-based computing job assignment procedure proposed in this invention. The job requests and the control/orchestration decisions are transmitted through the control channels between the computing network manager and the individual client or edge node. Such requests and/or decisions are light-weight information. Additionally, there are data channels between the client and the mobile edge node, and among the mobile edge nodes. These channels are used to send and receive data for computation and the computation results, which have larger size.

During the autonomous driving operation, each vehicle has its on-board computer with sufficient computation power that can handle most of the computation needs, such as analyzing the other vehicles, pedestrians, road signs, lanes, etc. However, if there are special occasions, such as an exceptionally large crowd or an accident nearby involving an unusual situation, the on-board computer (client) might not be able to handle all the computation needs in time. In such a case, the computing network manager will then direct some computation needs, along with the data, to the mobile edge nodes on the road side. These mobile edge nodes have stronger computation power (e.g. faster processors, larger memory, and more storage), therefore these large scale computing requests can be processed in time. The computing network manager will also coordinate to send the computing results back to the correct client. Furthermore, the computing network manager will periodically train the management mode (e.g., the two neural networks) based on the latest job request pattern and computation outcome for improve the job assignment decision.

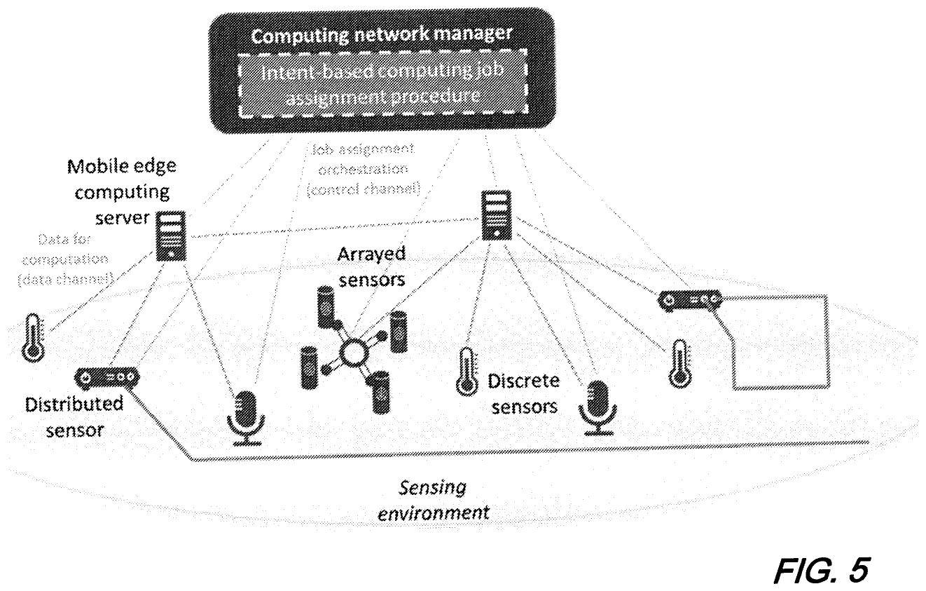

FIG. 5 is a schematic diagram showing illustrative sensor network application of our inventive method according to aspects of the present disclosure. As shown in this sensor network application—multiple sensors (such as distributed fiber optic sensors, accelerometers, geophones, thermometers, etc.) are connected in a network to monitor physical phenomena in a large area. This can also include other data from other input sources (such as video cameras and microphones) for data fusion and coordinated analysis. Some of these sensors include processors with certain computation power, which can analyze the data locally to extract environmental information. However, the processing power is often limited since it will add to the cost of the sensor hardware. Therefore, a computing network manager is set up and connected to all these sensors (clients) and those more powerful mobile edge computing servers. During the sensing network operation, the computing network manager analyzes the individual computing requests that arrives dynamically, as well as the computing network status, and then uses the proposed intent-based computing job assignment procedure to decide where to perform each computing task (at the local sensors or at the servers), based on the client's request intent and the available resource.

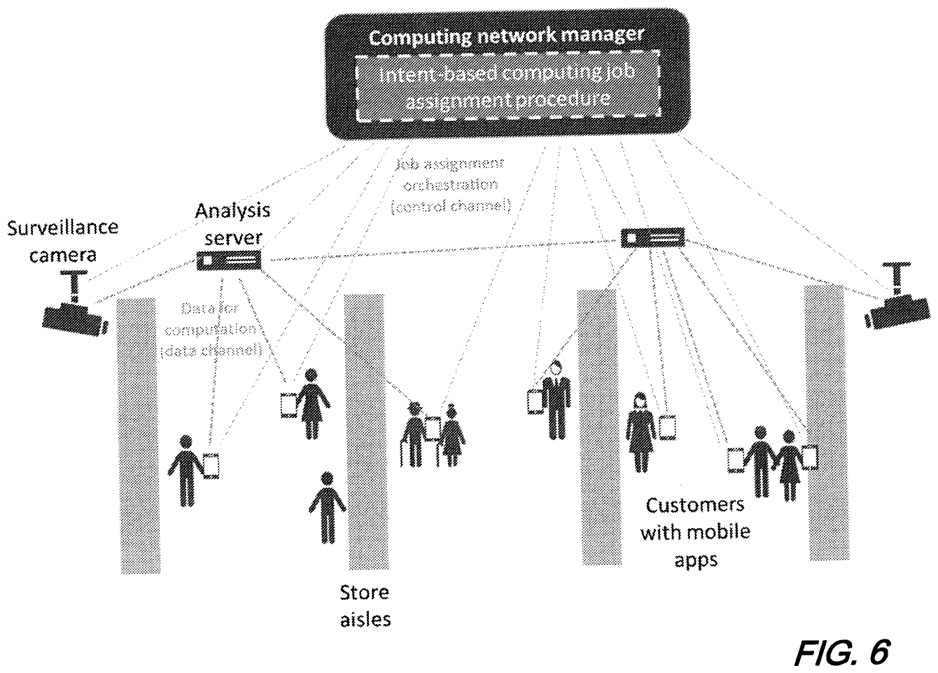

FIG. 6 is a schematic diagram showing illustrative smart retail application of our inventive method according to aspects of the present disclosure. As shown in this FIG. 6, the system includes the mobile apps installed at each client device, the cameras installed at the store, the analysis servers, and the computing network manager that connects all of them through the Internet or the local network. The client mobile device can perform certain computing tasks to analyze the specific client intent or interest, but the computing power of each mobile device varies and is often limited. Some cameras may also have local processors to perform simple video analysis. In order to have accurate analysis of the client intent and needs, long term monitoring is needed, and large amount of information collected from more locations is required. This needs to be done at the connected analysis server in the network. The computing network manager will assign the jobs based on the dynamically arriving requests using the proposed procedure, therefore the client can be better served by delivering the right information and product recommendations to them in a short time.

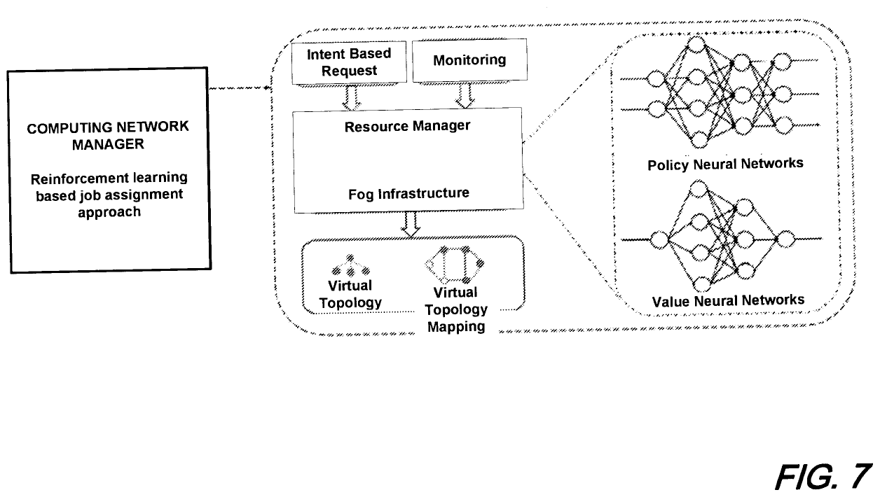

FIG. 7 is an illustrative application example of intent-based computing jobs framework in which an Infrastructure-as-a-Sensor (IaaSr) or Network-as-a-Sensor (NaaSr) system. Here, physical infrastructures not only traditional services such as communications and power distribution, but also sensing applications and services. While not specifically shown, there are multiple sensors—such as distributed fiber optic sensors, accelerometers, geophones, thermometers, etc., that are connected in a network to monitor physical phenomena such as road traffic, utility pole health, etc., in a large area.

The system may also leverage data from other input sources—such a video cameras and microphones—for data fusion and coordinated analysis. Some of these sensors may be equipped with processors that have certain computing power, so that they can analyze the data locally to extract the environmental information. However, such local processing power is oftentimes limited, and it will add to the cost of the sensor hardware. Therefore, fog computing along with intent-based computing jobs assignment framework can be used to accommodate these computing job requests in such a scenario.

A computing network manager is set up and connected to all these sensors (clients) and the more powerful fog nodes (run by fog computing carriers). During sensing network operation, the computing network manager interprets the intent from the clients' computing job requests, takes into consideration of the available resources and the status of the fog computing infrastructure, and then uses the proposed reinforcement learning-based approach to decide where and how to perform the computing tasks.

We can observe that, in the intent-based computing job assignment framework, a control channel and data channel are separated. The clients only send intent (small size) to, and/or receive resource allocation decision (small size) from, the computing network manager. The actual data (large size) to be processed involved in the large size actual data exchange between the clients and the fog nodes. In this manner, the computing network manager is not involved in the large size actual data exchange between the clients and the fog nodes, so the computing network manager will not be overloaded, and the operation is scalable.

The computing network manager runs the reinforcement learning-based solution to accommodate the client's requests that arrive dynamically. The reinforcement learning-based solution addresses three main challenges including: (1) how many virtual nodes will be used, (2) how to map the virtual nodes to the fog nodes to perform the computing tasks, and (3) how to establish the routing paths between the virtual nodes for exchanging data.

The reinforcement learning-based solution can adaptively and efficiently make the decision for the above three assignments, taking into consideration of the dynamically changing requests and the available computing and networking resources in the fog computing infrastructure. The details of the reinforcement learning model is described below. Here, we assume the fog puttinging infrastructure G(N,L) has N fog nodes and L physical links, and each client's computing jobs can be run on V virtual nodes at most. Between each fog node pairs, we pre-calculate the K shortest paths.

State: The state representation st, consists of the information about the computing job request's intent and the computing resources and networking resources utilization in the fog computing infrastructure. More specifically, it is a one-dimensional array of size 2+V+E, where V is the number of fog nodes and E is the number of physical links that connect the fog nodes. Here, the state includes the request intent of the data size and the computing model specified by the user (which accounts for two elements), the remaining computing resources among all the fog nodes (which account for the V elements), and the remaining networking resources in all the physical links (which account for the E elements).

Action: The action space of intent-based computing jobs assignment is large, as it needs to address how many virtual nodes to use, how to map the virtual nodes to the fog nodes and how to establish the routing paths between the virtual nodes. Assume the given computing jobs are run on I number of virtual nodes then there are C_{N}ⁱ ways to map the I virtual nodes to the N fog nodes. Hence, there are Σᵢ₌₁^{V} C_{N}ⁱ·K actions.

Reward: Each computing job request is associated with a reward that is defined simply as: 1 if the computing job request is successfully served (or accepted) by the fog computing infrastructure; −1 if the computing job request is blocked.

Policy Neural Networks: The policy neural network is used to determine the three assignments as mentioned above for the intent-based computing jobs The input is the state that includes the request intent and the remaining computing and networking resources in the fog computing infrastructure. The policy neural networks will generate a probability distribution over the action space, which is the output of the policy neural networks. In particular, the probability of each action is proportional to the discounted cumulative reward that is predicted by the value neural networks.

Value Neural Networks: The value neural network is used for predicting the discounted cumulative reward. The input is a V+E array consisting of the remaining computing and networking resources in the fog computing infrastructure after an action (one of the Σᵢ₌₁^{V} C_{N}ⁱ·K actions from the action space) is deployed. The output is the actual discounted cumulative rewards earned I an batch period.

Training: The training process of policy neural networks and the value neural networks are performed in a batch process, e.g., train the two neural networks in every 10 time units. In a batch processing period, the discounted cumulative rewards (the output of the value neural networks) can be actually calculated. Then, the discounted cumulative rewards can be used to update the value neural networks to make a more accurate prediction for the probability distribution over the action space, so that the policy neural networks is adaptively and effectively updated to make a more efficient assignment for the number of virtual nodes used, and the virtual node mapping and the virtual link mapping.

Our evaluations produced observations that intent-RL achieves higher utilization in terms of both computing resources and network resources as compared to Intent-Random. This demonstrates that our inventive Intent-RL can help fog computing to efficiently use their physical resources. The high resource utilization is also one reason why Intent-RL can accommodate more intent-based computing jobs than Intent-Random.

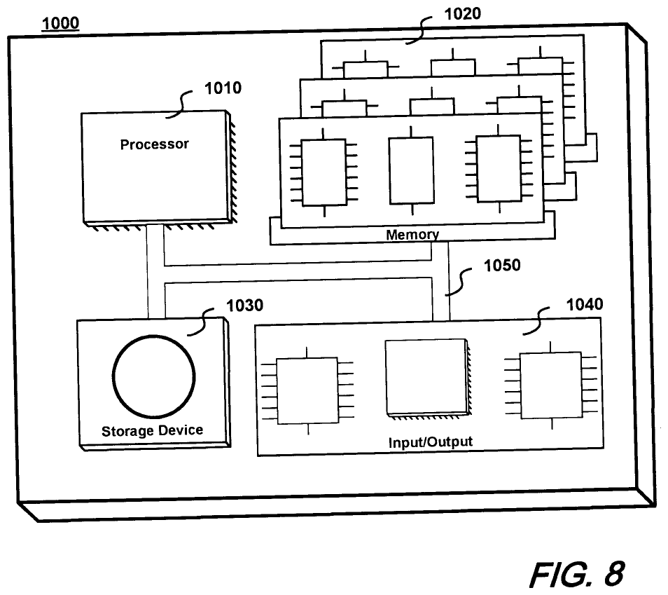

FIG. 8 is a schematic diagram showing illustrative computer structure that may be used in conjunction with our inventive method according to aspects of the present disclosure.

At this point, while we have presented this disclosure using some specific examples, those skilled in the art will recognize that our teachings are not so limited. Accordingly, this disclosure should be only limited by the scope of the claims attached hereto.

1. A dynamic, intent-based network computing job assignment method using reinforcement learning, the method comprising the steps of:
a) define a discounted cumulative reward function;
b) define an action space;
c) create a policy neural network (policy NN);
d) create a value neural network (value NN);
e) while there exists a new request r;
f) add the request r and a current network state s to a batch;
g) use request r and current network state s as input to policy NN and predict a reward distribution over the action space;
h) select an action that has a maximum predicted reward relative to other actions;
i) using the selected action, determine to accept or reject the request r, deploy the action, and update physical resources if the request is accepted;
j) if a size of the batch is equal to a threshold
then
k) train the value NN; and
l) train the policy NN;
else repeat steps e)-j);
k) repeat steps e)-j.
